(19) United States
(12) Patent Application Publication
(10) Pub. No.: US 2023/0185961 A1
(43) Pub. Date: Jun. 15, 2023

(54) DATA BLURRING

(71) Applicant: Business Objects Software Ltd., Dublin (IE)

(72) Inventor: Arnaud Nouard, D'Huison-Longueville (FR)

(21) Appl. No.: 17/547,568

(22) Filed: Dec. 10, 2021

(51) Int. Cl. G06F 21/62; G06F 40/186

(52) U.S. Cl. CPC G06F 21/6254; G06F 40/186; G06F 2221/2141

(57) ABSTRACT

A first user may generate a report that includes multiple data values. A second user may be granted access to some of the data values but not others. To accommodate the partial access permission, an application server may generate a version of the report that includes only the data values the second user is permitted to access. The data values that the second user is not permitted to access may be replaced by randomly generated character strings. A blurring effect may be applied to the replacement data values, providing a visual indication that the replacement data values are not the actual data values. Some data values of the report may depend on other data values. Both data values to which the user has explicitly been denied access and data values that depend on them are replaced in the generated version of the report.

### TECHNICAL FIELD

The subject matter disclosed herein generally relates to data blurring. Specifically, the present disclosure addresses systems and methods to provide privacy for data.

### BACKGROUND

Documents are manually redacted by users that select the portions of the documents to remove or obfuscate. Redacted and non-redacted versions of documents are stored independently.

### BRIEF DESCRIPTION OF THE DRAWINGS

FIG. 1 is a network diagram illustrating an example network environment suitable for providing privacy for data.

FIG. 2 is a block diagram of an example application server suitable for providing privacy for data.

FIG. 3 is a block diagram of an example database schema suitable for storing data and privacy metadata for use in providing privacy for data.

FIG. 4 is a block diagram of an example user interface that shows data in a report.

FIG. 5 is a block diagram of an example user interface that shows blurred data in a report.

FIG. 6 is a flowchart illustrating operations of an example method suitable for generating a document using blurred data.

FIG. 7 is a block diagram showing one example of a software architecture for a computing device.

FIG. 8 is a block diagram of a machine in the example form of a computer system within which instructions may be executed for causing the machine to perform any one or more of the methodologies discussed herein.

### DETAILED DESCRIPTION

Example methods and systems are directed to protecting privacy for data. A first user may generate a report that includes multiple data values. A second user may be granted access to some of the data values but not others. To accommodate the partial access permission, an application server may generate a version of the report that includes only the data values the second user is permitted to access. The data values that the second user is not permitted to access may be replaced by randomly generated character strings. A blurring effect may be applied to the replacement data values, providing a visual indication that the replacement data values are not the actual data values.

Some data values of the report may depend on other data values. For example, a report may include regional revenue data and a total revenue obtained by summing the regional revenues. When a version of the report is generated for a user that does not have access to revenue data for one or more of the regions, the application server automatically determines that the user does not have access to the total revenue, based on the dependency between the two data values. Accordingly, both the data value to which the user has explicitly been denied access and the dependent data value are replaced in the generated version of the report.

The replacement character strings may be generated with attributes (e.g., language, font, font size, color, style, numeric/non-numeric, capitalization, or any suitable combination thereof) based on the data value being replaced. For example, a data value comprising an English-language character string may be replaced by an English-language character string of the same length, with the position of capital letters kept the same. As another example, a data value comprising a dollar sign followed by numeric digits may be replaced by a character string comprising a dollar sign followed by the same number of random numeric digits. By using the attributes based on the data value being replaced, the replacement character string may be the same size as the character string being replaced. Thus, replacing the character string does not affect layout of the generated report (e.g., location of line breaks, widths of automatically sized columns in tables, locations of page breaks, or any suitable combination thereof).

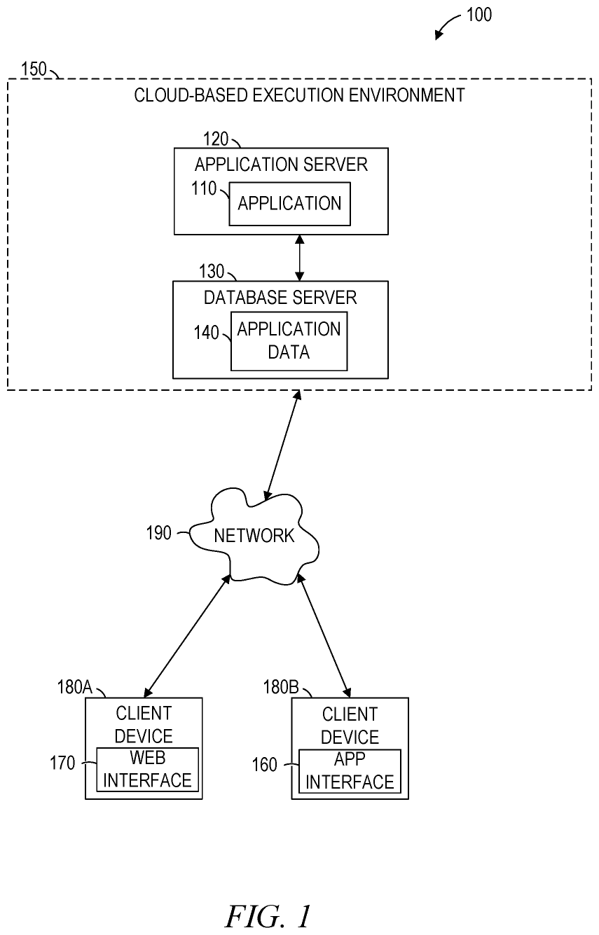

FIG. 1 is a network diagram illustrating an example network environment 100 suitable for providing privacy for data. The network environment 100 includes a cloud-based execution environment 150, client devices 180A and 180B, and a network 190. The cloud-based execution environment 150 includes an application server 120 and a database server 130. The application server 120 provides an application 110. The application server 120 accesses application data (e.g., application data stored by the database server 130) to provide the application 110 to the client devices 180A and 180B via a web interface 170 or an application interface 160.

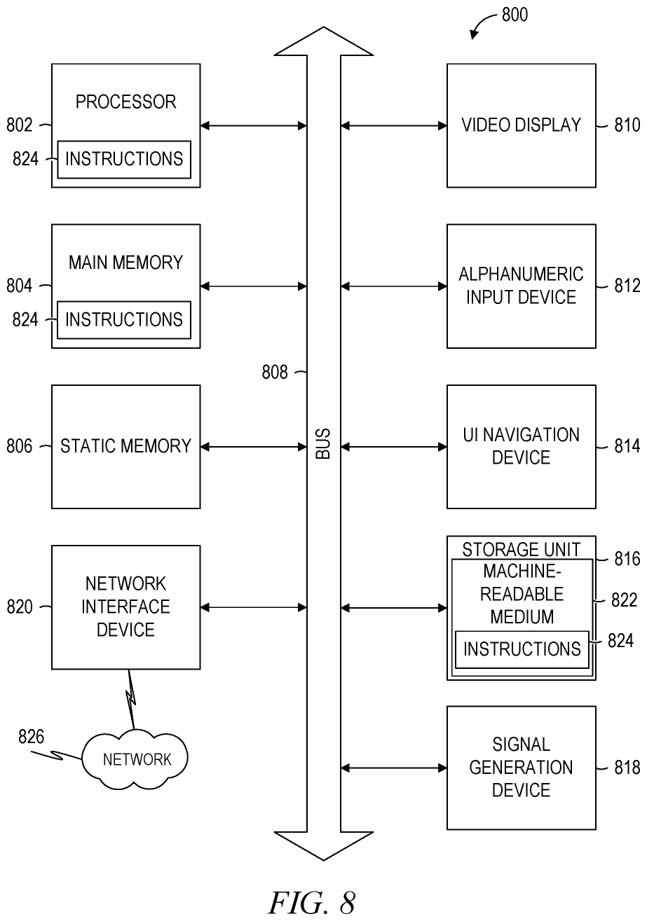

The application server 120, the database server 130, and the client devices 180A and 180B may each be implemented in a computer system, in whole or in part, as described below with respect to FIG. 8. The client devices 180A and 180B may be referred to collectively as client devices 180 or generically as a client device 180.

A database of the database server 130 stores data for use by the application server 120. For example, user data (e.g., name, address, phone number, account number, birthdate, social security number, or any suitable combination thereof), accounting data (e.g., revenue, profits, expenses, credits, debits, or any suitable combination thereof), or any suitable combination thereof may be stored in the database. The network-based application may provide a user interface to the client devices 180 that allow users to generate or view reports that are based on the data stored in the database. For example, a user report may show information about users (e.g., all users, users with addresses in a particular geographic region, users with demographic data matching specified criteria, or any suitable combination thereof). As another example, a financial report may show information about finances of an individual, a business, or a business unit.

The reports may be presented to different users with different data in the report protected by data blurring. For example, a leader of a business unit may be permitted to see all data in a report for the business unit, but only a subset of data in a report for the overall business. An employee of the business unit may be permitted to view only a subset of the data in the report for the business unit, and not permitted to view the report for the overall business at all. One method of generating the different versions of the reports is to generate the full report and then to manually black out the protected data to create a redacted version. This process is repeated for each different redacted version, and repeated each time an updated version of the report is generated (e.g., to include more recent data).

As described herein, different versions of reports are generated automatically based on permissions defined for the viewing user. When a report is updated to include new data, a version of the updated report for the viewing user includes the updated data without accessing data the user is not permitted to access or requiring manual intervention.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 8. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the database server 130, and the client devices 180A-180B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

By way of example and not limitation, the application 110 is shown as being provided by the single application server 120 in communication with the single database server 130. However, the cloud-based execution environment 150 may comprise multiple application servers and multiple database servers, with the application 110 being dynamically allocated to one or more of the multiple application servers and the application data 140 being stored on one or more of the multiple database servers (e.g., using replication, clustering, sharding, mirroring, or any suitable combination thereof).

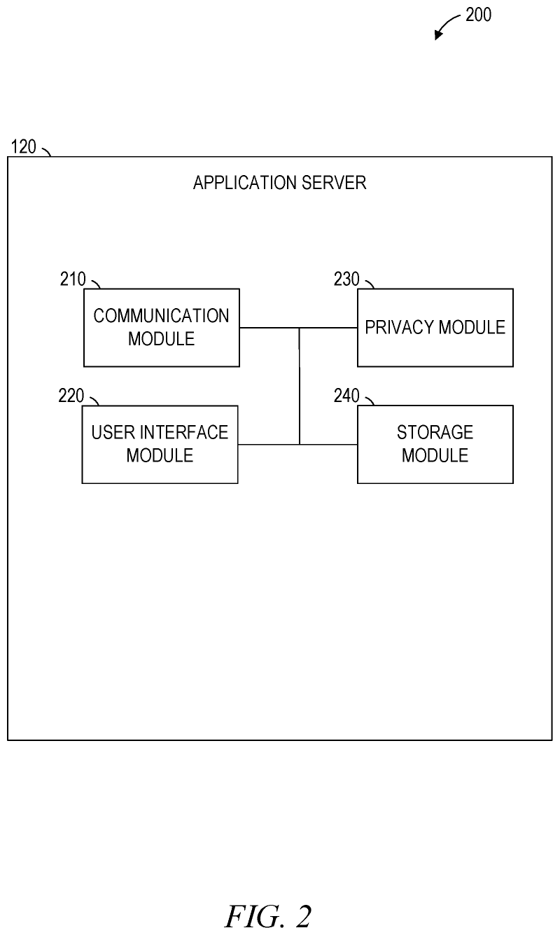

FIG. 2 is a block diagram 200 of an example application server 120 suitable for providing privacy for data. The application server 120 is shown as including a communication module 210, a user interface module 220, a privacy module 230, and a storage module 240, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the application server 120 and transmits data from the application server 120. For example, the communication module 210 may receive, from the client device 180A or 180B, data to be stored by the database server 130, report definitions for reports to be generated by the application server 120, requests for reports, or any suitable combination thereof. Communications sent and received by the communication module 210 may be intermediated by the network 190.

The user interface module 220 generates a user interface for display on a display device of the client devices 180A and 180B. For example, the user interface module 220 may generate a hypertext markup language (HTML) file and cause the communication module 210 to send the HTML file to the client device 180A via the network 190. The web interface 170 (e.g., a web browser) of the client device 180A renders a user interface on a display device of the client device 180A based on the HTML file.

The privacy module 230 accesses data from the database server 130 and, based on the accessed data and permissions of the user account for which the data is being accessed, generates substitute values for display. For example, a user that does not have access to the social security numbers of other users, but does have access to other data in a report, may receive a version of the report in which the social security numbers of the other users are replaced with random nine-digit numbers. Thus, the results provided are similar to the actual results, keeping the overall appearance of the report the same, but the recipient does not actually access the protected data values. As a further visual effect, the user interface module 220 or the privacy module 230 may visually blur the substitute data values.

The storage module 240 stores the permission metadata that controls which users may access data and other data used by the privacy module 230 to modify data to protect privacy. The storage module 240 may store programming instructions for the communication module 210, the user interface module 220, the privacy module 230, or any suitable combination thereof.

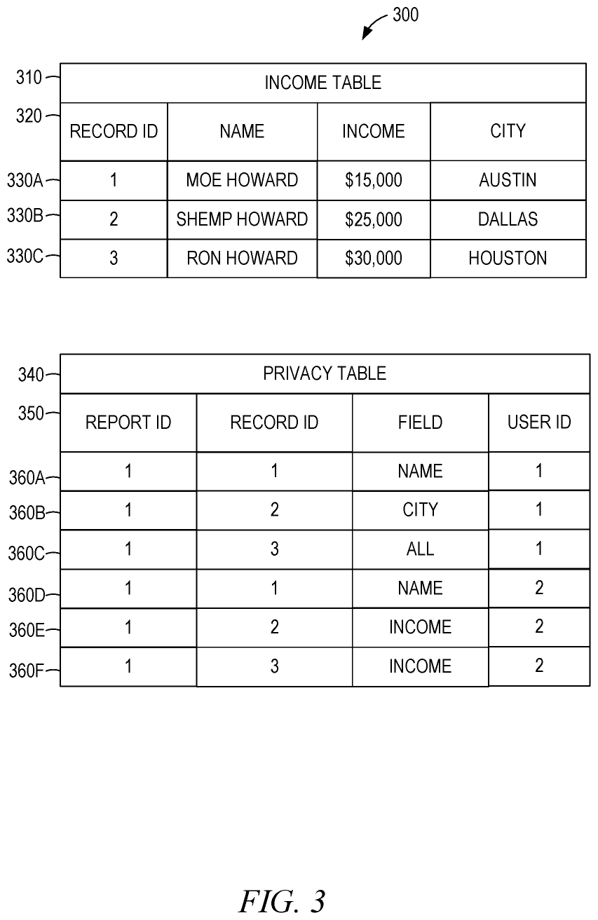

FIG. 3 is a block diagram of an example database schema 300 suitable for storing data and privacy metadata for use in providing privacy for data. The database schema 300 includes an income table 310 and a privacy table 340. The income table 310 includes rows 330A, 330B, and 330C of a format 320. The privacy table 340 includes rows 360A, 360B, 360C, 360D, 360E, and 390F of a format 350.

Each row of the income table 310 stores record identifier (ID), name, income, and city for a user. The record ID field stores a unique identifier for the user. Thus, the row 330A indicates that Moe Howard has an income of $15,000 and lives in Austin; the row 330B indicates that Shemp Howard has an income of $25,000 and lives in Dallas; and the row 330C indicates that Ron Howard has an income of $30,000 and lives in Houston.

The privacy table 340 stores metadata that indicates which fields of the income table 310 are to be kept private from users. To facilitate this, in the example of FIG. 3, each row of the privacy table 340 stores a report ID and a user ID, indicating the user from which data in the identified report is being withheld. The data being withheld is identified by the record ID and the field. Thus, by cross-referencing the record ID field of the privacy table 340 with the record ID field of the income table 310, the row 360A indicates that Moe Howard's name is being kept private from user ID 1 in report ID 1. The row 360C indicates that all fields (e.g., name, income, and city) of record ID 3 (row 330C) are being kept private from user ID 1 in report ID 1. The rows 360D-360F apply to user ID 2 for the same report, and indicate that user ID 2 is not permitted to access the income field for any of the rows 330A-330C.

By way of example and not limitation, the privacy table 340 is shown as identifying the records and fields to which identified users are to be prevented access in individual reports, but other methods of identifying which data is to be kept private are contemplated. For example, privacy may be protected at a group level rather than (or in addition to) at the user level. Thus, a group table may store the relationships between users and groups, and the privacy table 340 may indicate whether particular fields are to be provided to or protected from various groups. When a report is generated for a user, the user/group relationship and the group/privacy relationships are accessed to determine which fields the user is permitted to access.

As another example, the inverse of the privacy table 340 may be stored, indicating which users (or groups) are permitted to access data rather than which users (or groups) are not permitted to access data. Additionally, privacy may be protected based on other information about the version of the report being generated. For example, fields may be kept private in a version of the report being presented on a web browser but not in a version being presented in a dedicated application.

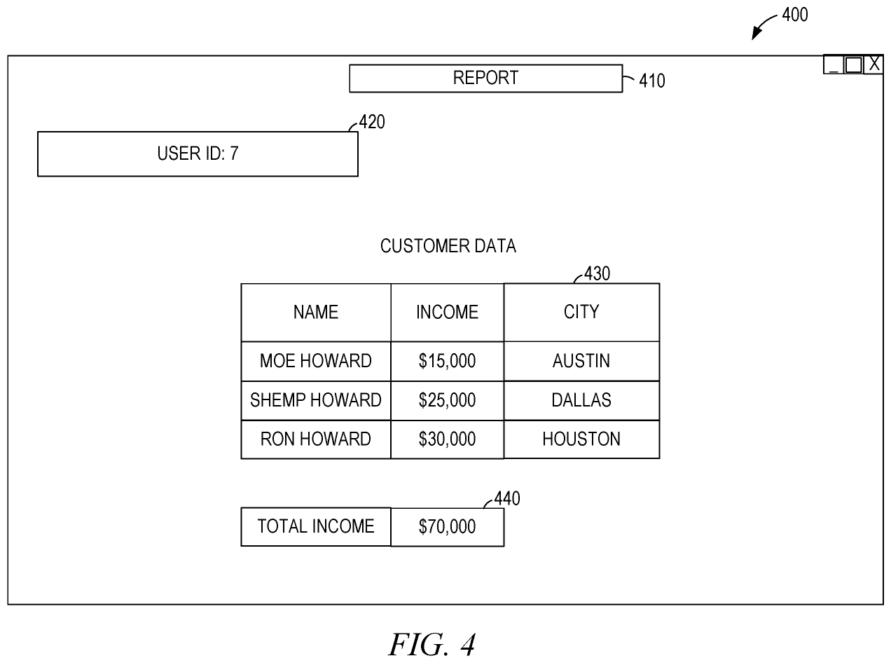

FIG. 4 is a block diagram of an example user interface 400 that shows data in a report. The user interface 400 includes a title 410, a user identifier 420, table 430, and data 440. The title 410 indicates that the user interface 400 is showing a report. The user identifier 420 indicates that the user for whom the report has been prepared is the user with ID 7. Since the privacy table 340 does not indicate that this user has restricted access to any of the data in the report, the data shown in the table 430 and the data 440 is unblurred.

The table 430 shows name, income, and city data from the rows 330A-330C of the income table 310. The data 440 shows the total income for the listed individuals. The total income may be generated dynamically from the individual income values.

The user interface 400 may be used to receive selections of data values to be blurred. For example, a presented data value (e.g., the $15,000 income in the first row of the report) may be selected. In response, a menu is presented allowing the user to select an option to protect the corresponding data value. The application server 120 accesses a document template for the presented report and, based on the document template and the selected portion of the user interface 400, determines the data value to be blurred.

Example pseudocode for a template for the report shown in the user interface 400 is shown below:

<title>CUSTOMER DATA</title>
<table>
<tr><td>NAME</td><td>INCOME</td><td>CITY</td></tr>
<tr><td>$Name[1]</td><td>$Income[1]</td><td>$City[1]</td></tr>
<tr><td>$Name[2]</td><td>$Income[2]</td><td>$City[2]</td></tr>
<tr><td>$Name[3]</td><td>$Income[3]</td><td>$City[3]</td></tr>
</table>
<table>
<tr><td>TOTAL
INCOME</td><td>$Income[1]+$Income[2]+$Income[3]</td></tr>
</table>

Thus, in this example, the selected value of $15,000 was generated from the source code $Income[1], which is the Income field of the row 330A of the income table 310 of FIG. 3. In response, the privacy module 230 modifies the privacy table 340 to protect the selected data. As another example, the total income value ($70,000) of the data 440 may be selected for protection. The underlying source code shows that the total income value was generated from $Income[1], $Income[2], and $Income[3]. In response to this selection, the privacy module 230 may modify the privacy table 340 to protect all three of the underlying data values.

The associated right to enable or disable protection of data values may be managed by administrative permissions. For example, only the creator of the report may be permitted to alter the permissions for data in the report for other users.

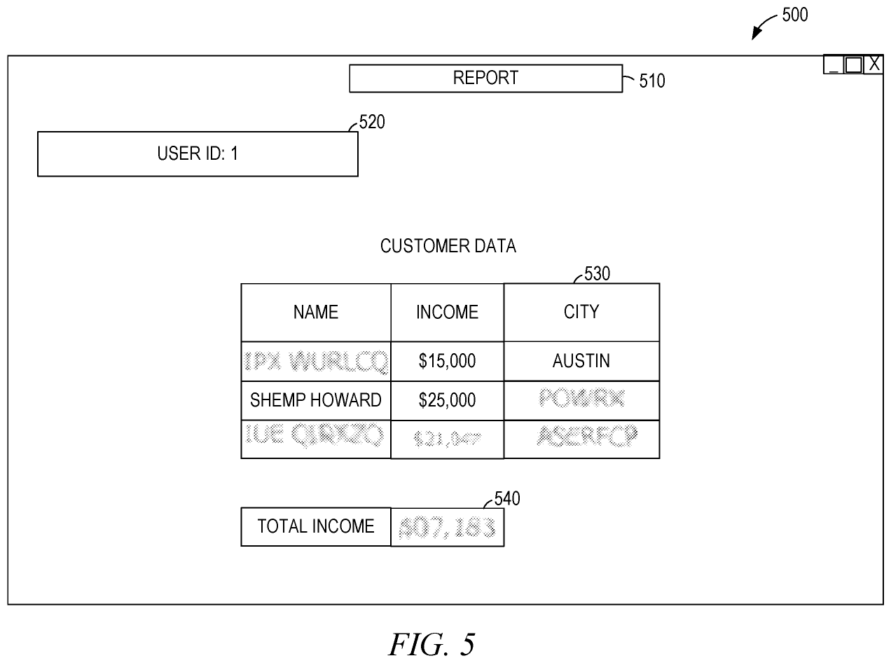

FIG. 5 is a block diagram of an example user interface 500 that shows blurred data in a report. The user interface 500 includes a title 510, a user identifier 520, table 530, and data 540. As in the user interface 400 of FIG. 4, the title 510 indicates that the user interface 500 is displaying a report. The user identifier 520 indicates that the report for whom the report of FIG. 5 was generated is the user with identifier 1.

Rows 360A-360C of the privacy table 340 of FIG. 3 indicate that data from identified fields of the income table 310 should be blurred when the report is generated for this user. Accordingly, the table 530 of FIG. 5 includes the unblurred income and city from the row 330A and the unblurred name and income from the row 330B of FIG. 3. The remaining data in the table 530 is blurred in accordance with the data in the privacy table 340 of FIG. 3. Additionally, the data 540 is blurred, since the total income depends on the income from record ID 3 in the income table 310 and that field is being kept private from user ID 1, as indicated in the row 360C of the privacy table 340 of FIG. 3.

The blurring of the displayed data in the example of FIG. 5 is a two-step process. First, the actual data values are replaced with similar randomized strings. For example, the name “Moe Howard” may be replaced with a random 10-character string that comprises alphabetic characters and spaces only. As another example, the name “Moe Howard” may be replaced by a 3-character string and a 7-character string, both of which comprise alphabetic characters, with the two strings separated by a space. As still another example, the income “$30,000” may be replaced by a similarly formatted five-digit value, such that the dollar sign and comma remain in place. After the actual data values are replaced with randomized strings, the replacement values are modified with a blurring effect.

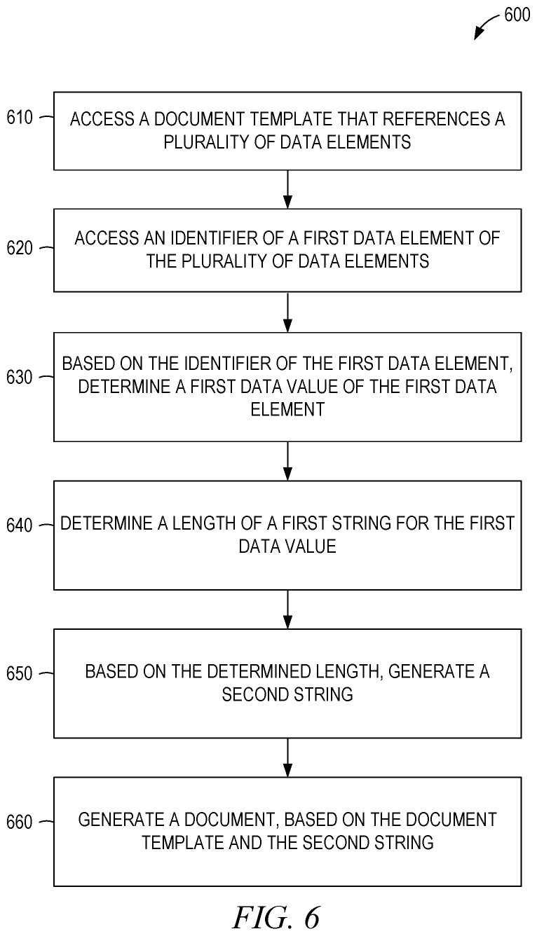

FIG. 6 is a flowchart illustrating operations of an example method suitable for generating a document using blurred data. The method 600 includes operations 610, 620, 630, 640, 650, and 660. By way of example and not limitation, the method 600 may be performed by the application server 120 of FIG. 1, in communication with the database server 130 and the client devices 180, using the modules, databases, structures, and user interfaces shown in FIGS. 2-5.

In operation 610, one or more processors of the application server 120 access a document template that references a plurality of data elements. In the example pseudocode discussed above with respect to FIG. 4, $Name, $Income, and $City are used to reference the name, income, and city fields of the row of the income table 310 of FIG. 3 identified by the record ID enclosed in square brackets. Thus, in operation 610, the accessed document template references three data elements for each of three records, for a total of nine data elements.

In operation 620, the application server 120 of FIG. 1 accesses an identifier of a first data element of the plurality of data elements. The identifier may comprise a record ID, a field name, or a combination thereof. For example, $Name[1] may be the accessed identifier, indicating the data element of the name of record ID 1.

The application server 120 of FIG. 1, in operation 630, determines a first data value of the first data element based on the identifier of the first data element. In this example, the first data value is “Moe Howard,” the value in the name field of the row 330A having the record ID of 1.

The determining of the first data value of the first data element based on the identifier of the first data element may be an indirect operation. For example, the total income being displayed in the report depends on the income for record ID 1 and the row 360C of the privacy table 340 of FIG. 3 indicates that user ID 1 is not to be given access to the any fields for record ID 3, including the income. As a result, the application server 120 determines the total value of the first data (in this case, the total income) to be $70,000, based on the identifier of the first data element (in this case, $Income[3], an identifier for the income of record ID 3) and the document template (identifying $Income[1]+$Income[2]+$Income[3] as a data value to be included in the report).

In operation 640, the privacy module 230 of FIG. 2 of the application server 120 of FIG. 1 determines a length of a first string for the first data value. For example, the string representation of “Moe Howard” is ten characters long. As another example, the string representation of $70,000 is seven characters long.

As a further example, the data value determined in operation 630 may not be stored in a string format. The income values of the income table 310 of FIG. 3 may be stored as 32-bit floating point numbers, for example. Thus, the determining of the length of the string for the data value may include a step of converting a binary data value to a string representation.

The replacement character strings may be generated with attributes (e.g., language, font, font size, color, style, numeric/non-numeric, or any suitable combination thereof) based on the data value being replaced. For example, a data value comprising an English-language character string may be replaced by an English-language character string of the same length. As another example, a data value comprising a dollar sign followed by numeric digits may be replaced by a character string comprising a dollar sign followed by the same number of random numeric digits. By using the attributes based on the data value being replaced, the replacement character string may be the same size as the character string being replaced. Thus, replacing the character string does not affect layout of the generated report (e.g., location of line breaks, widths of automatically sized columns in tables, locations of page breaks, or any suitable combination thereof).

The privacy module 230 of FIG. 2 generates a second string based on the determined length (operation 650). For example, a random string of the determined length may be generated. As an alternative to generating a string of the same length as the string it replaces, sub-strings within the first string may be replaced by similar sub-strings. For example, a predetermined set of characters may be used to separate sub-strings. Characters in the first string that are in the predetermined set of characters are copied to the second string without modification. Each sub-string is categorized and replaced with randomly generated strings having one or more matching attributes (e.g., numeric only, alphabetic only, alphanumeric only, sub-string length, font, font size, style (e.g., italics, bold, underline), or any suitable combination thereof). Thus, when a replacement sub-string is generated to have the same length as the original sub-string and the original sub-string is determined to contain only numbers and the replacement substring is generated with the numeric only attribute, the replacement string is generated, at least in part, based on the number of digits in the first string. Similarly, when a replacement sub-string is generated to have the same length as the original sub-string and the original sub-string is determined to contain only letters, and the replacement substring is generated with the alphabetic-only attribute, the replacement string is generated, at least in part, based on the number of letters in the first string.

Operations 640 and 650 may be performed based on a determination that a user for whom the document is being generated does not have permission to access the first data value (e.g., based on data stored in the privacy table 340 of FIG. 3). As with the determination of the first data value, the determination that the user for whom the document is being generated does not have permission to access the first data value may be an indirect determination. For example, a user that is not permitted to access the income field of record ID 1 may also not be permitted to access any results that depend on the denied field, such as the total income of the three records.

Thus, the method 600 may be started by receiving a request that comprises an account identifier for a user requesting the report, and the method 600 may include determining, based on the account identifier, to generate the second string.

In operation 660, the user interface module 220 generates a document, based on the document template and the second string. For example, the second string may be presented in the document in a location indicated by the document template for the first data value. Thus, the randomly generated second string appears in place of the first data value, preserving the formatting of the report without sharing protected data with the user. The privacy module 230 of FIG. 2 may apply a blur effect to the second string as part of the generating of the document by the user interface module 220. As a result, the user is informed that the second string is not real data for the document, but instead is replacement data included to protect the privacy of the corresponding real data.

By way of example and not limitation, the method 600 is described as using a replacement string for a data value for a single data value (the discussed “first data value”). However, any number of data values may be replaced. For example, in FIG. 3 the rows 360A-360C of the privacy table 340 identify six data values to be kept private from user ID 1; the rows 360D-360F identify three data values to be kept private from user ID 2. Additionally, any number of dependent values (e.g., total income) may be indirectly protected by virtue of the privacy settings in the privacy table 340.

The method 600 may be repeated for different users accessing the same report. Each different user may receive a different version of the report, depending on the data in the privacy table 340 of FIG. 3 for the requesting user. Thus, for a first user, a first data value may be replaced and blurred and, for a second user, the first data value may be included in the report. With reference to the privacy table 340, user IDs 1 and 2 both will have the Name field for record ID 1 replaced and blurred (rows 360A and 360D), but user ID 1 will see some data values that user ID 2 will not (e.g., the Income field for record ID 2) and user ID 2 will see some data values that user Id 1 will not (e.g., the City fields for record IDs 2 and 3 and the City field for record ID 3).

The method 600 may be used as part of a customer service or information technology (IT) application. For example, a user may encounter a bug when generating a large report, but not wish to share confidential data included in the report with technical support personnel. By selecting some (or all) of the data for blurring, the user may be able to share the large report and still cause the bug to occur without sharing the blurred data.

In view of the herein described implementations of subject matter, this application discloses the following list of examples, wherein one feature of an example in isolation or more than one feature of an example, taken in combination and, optionally, in combination with one or more features of one or more further examples are further examples also falling within the disclosure of this application.

Example 1 is a method comprising: accessing, by one or more processors of a device, a document template that references a plurality of data elements; accessing, by the one or more processors, an identifier of a first data element of the plurality of data elements; based on the identifier of the first data, determining a first data value of the first data; determining a length of a first string representation of the first data value; based on the determined length, generating a second string; and generating, based on the document template and the second string, a document.

In Example 2, the subject matter of Example 1, wherein: the generating of the second string comprises randomly generating the second string with the length of the first string.

In Example 3, the subject matter of Examples 1-2, wherein: the generating of the document comprises applying a blur effect to the second string.

In Example 4, the subject matter of Examples 1-3 includes receiving a request that comprises an account identifier; and determining, based on the account identifier, to generate the second string.

In Example 5, the subject matter of Example 4 includes receiving a second request that comprises a second account identifier; in response to the second request, generating, based on the document template, a document comprising the first string.

In Example 6, the subject matter of Examples 1-5 includes based on the identifier of the first data and the document template, determine a second data value that depends on the value of the first data; determining a second length of a third string representation of the second data value; and based on the determined second length, generating a fourth string; wherein the generating of the document is further based on the fourth string.

In Example 7, the subject matter of Examples 1-6 includes determining a font size of the first string; wherein the generating of the second string is further based on the font size.

In Example 8, the subject matter of Examples 1-7 includes determining a color of the first string; wherein the generating of the second string is further based on the color.

In Example 9, the subject matter of Examples 1-8 includes determining a font of the first string; wherein the generating of the second string is further based on the font.

In Example 10, the subject matter of Examples 1-9 includes determining that the first string comprises a number of digits; wherein the generating of the second string is further based on the number of digits.

In Example 11, the subject matter of Examples 1-10 includes determining that the first string comprises a number of letters; wherein the generating of the second string is further based on the number of letters.

Example 12 is a device comprising: a memory that stores instructions; and one or more processors configured by the instructions to perform operations comprising: accessing a document template that references a plurality of data elements; accessing an identifier of a first data element of the plurality of data elements; based on the identifier of the first data, determining a first data value of the first data; determining a length of a first string representation of the first data value; based on the determined length, generating a second string; and generating, based on the document template and the second string, a document.

In Example 13, the subject matter of Example 12, wherein: the generating of the second string comprises randomly generating the second string with the length of the first string.

In Example 14, the subject matter of Examples 12-13, wherein: the generating of the document comprises applying a blur effect to the second string.

In Example 15, the subject matter of Examples 12-14, wherein the operations further comprise: receiving a request that comprises an account identifier; and determining, based on the account identifier, to generate the second string.

In Example 16, the subject matter of Example 15, wherein the operations further comprise: receiving a second request that comprises a second account identifier; and in response to the second request, generating, based on the document template, a document comprising the first string.

Example 17 is a non-transitory computer-readable medium that stores instructions that, when executed by one or more processors of a device, cause the one or more processors to perform operations comprising: accessing a document template that references a plurality of data elements; accessing an identifier of a first data element of the plurality of data elements; based on the identifier of the first data, determining a first data value of the first data; determining a length of a first string representation of the first data value; based on the determined length, generating a second string; and generating, based on the document template and the second string, a document.

In Example 18, the subject matter of Example 17, wherein the operations further comprise: based on the identifier of the first data and the document template, determine a second data value that depends on the value of the first data; determining a second length of a third string representation of the second data value; and based on the determined second length, generating a fourth string; wherein the generating of the document is further based on the fourth string.

In Example 19, the subject matter of Examples 17-18, wherein the operations further comprise: determining a font size of the first string; wherein the generating of the second string is further based on the font size.

In Example 20, the subject matter of Examples 17-19, wherein the operations further comprise: determining a color of the first string; wherein the generating of the second string is further based on the color.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

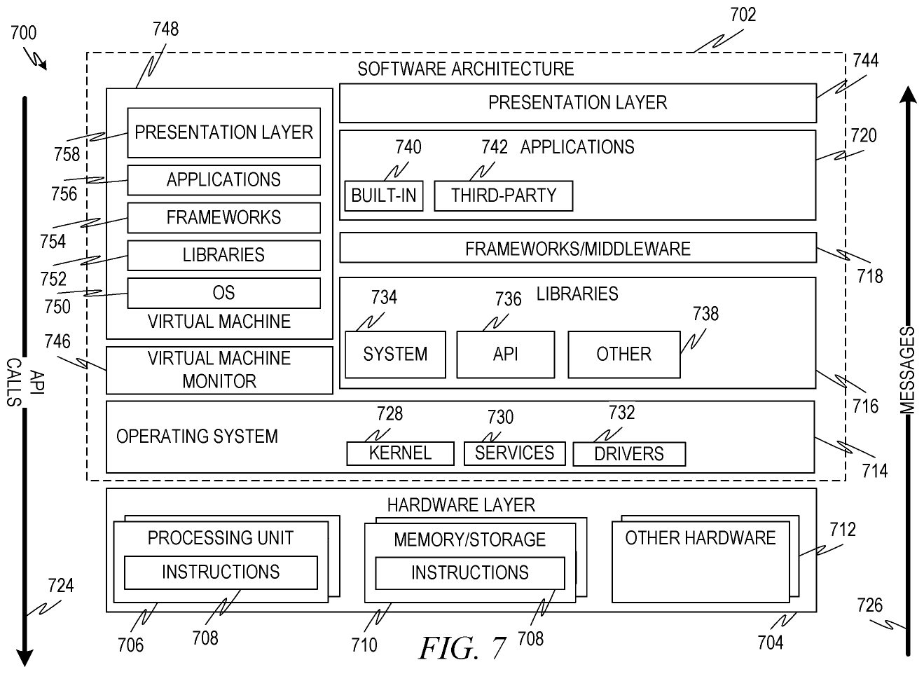

FIG. 7 is a block diagram 700 showing one example of a software architecture 702 for a computing device. The software architecture 702 may be used in conjunction with various hardware architectures, for example, as described herein. FIG. 7 is merely a non-limiting example of a software architecture, and many other architectures may be implemented to facilitate the functionality described herein. A representative hardware layer 704 is illustrated and can represent, for example, any of the above referenced computing devices. In some examples, the hardware layer 704 may be implemented according to the architecture of the computer system of FIG. 7.

The representative hardware layer 704 comprises one or more processing units 706 having associated executable instructions 708. Executable instructions 708 represent the executable instructions of the software architecture 702, including implementation of the methods, modules, subsystems, components, and so forth described herein and may also include memory and/or storage modules 710, which also have executable instructions 708. Hardware layer 704 may also comprise other hardware as indicated by other hardware 712 which represents any other hardware of the hardware layer 704, such as the other hardware illustrated as part of the software architecture 702.

In the example architecture of FIG. 7, the software architecture 702 may be conceptualized as a stack of layers where each layer provides a particular functionality. For example, the software architecture 702 may include layers such as an operating system 714, libraries 716, frameworks/middleware 718, applications 720, and presentation layer 744. Operationally, the applications 720 and/or other components within the layers may invoke application programming interface (API) calls 724 through the software stack and access a response, returned values, and so forth illustrated as messages 726 in response to the API calls 724. The layers illustrated are representative in nature and not all software architectures have all layers. For example, some mobile or special purpose operating systems may not provide a frameworks/middleware 718 layer, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service. The interrupt service may detect the receipt of an interrupt and, in response, cause the software architecture 702 to pause its current processing and execute an interrupt service routine (ISR) when an interrupt is accessed.

The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks/middleware 718 may provide a higher-level common infrastructure that may be utilized by the applications 720 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. Third-party applications 742 may include any of the built-in applications as well as a broad assortment of other applications. In a specific example, the third-party application 742 (e.g., an application developed using the Android™ or iOS™ software development kit (SDK) by an entity other than the vendor of the particular platform) may be mobile software running on a mobile operating system such as iOS™, Android™ Windows® Phone, or other mobile computing device operating systems. In this example, the third-party application 742 may invoke the API calls 724 provided by the mobile operating system such as operating system 714 to facilitate functionality described herein.

The applications 720 may utilize built in operating system functions (e.g., kernel 728, services 730 and/or drivers 732), libraries (e.g., system libraries 734, API libraries 736, and other libraries 738), frameworks/middleware 718 to create user interfaces to interact with users of the system. Alternatively or additionally, in some systems, interactions with a user may occur through a presentation layer, such as presentation layer 744. In these systems, the application/module “logic” can be separated from the aspects of the application/module that interact with a user.

Some software architectures utilize virtual machines. In the example of FIG. 7, this is illustrated by virtual machine 748. A virtual machine creates a software environment where applications/modules can execute as if they were executing on a hardware computing device. A virtual machine is hosted by a host operating system (operating system 714) and typically, although not always, has a virtual machine monitor 746, which manages the operation of the virtual machine 748 as well as the interface with the host operating system (i.e., operating system 714). A software architecture executes within the virtual machine 748 such as an operating system 750, libraries 752, frameworks/middleware 754, applications 756 and/or presentation layer 758. These layers of software architecture executing within the virtual machine 748 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages; and, it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 8 is a block diagram of a machine in the example form of a computer system 800 within which instructions 824 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804, and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a user interface (UI) navigation (or cursor control) device 814 (e.g., a mouse), a storage unit 816, a signal generation device 818 (e.g., a speaker), and a network interface device 820.

### Machine-Readable Medium

The storage unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, with the main memory 804 and the processor 802 also constituting machine-readable media 822.

While the machine-readable medium 822 is shown in FIG. 8 to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with such instructions 824. The term “machine-readable medium” shall accordingly be taken to include, but not be limited to, solid-state memories, and optical and magnetic media. Specific examples of machine-readable media 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 824 may further be transmitted or received over a communications network 826 using a transmission medium. The instructions 824 may be transmitted using the network interface device 820 and any one of several well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, by one or more processors of a device, a document template that references a plurality of data elements;
accessing, by the one or more processors, an identifier of a first data element of the plurality of data elements;
based on the identifier of the first data element, determining a first data value of the first data element;
determining a length of a first string for the first data value;
based on the determined length, generating a second string; and
generating, based on the document template and the second string, a document.

2. The method of claim 1, wherein:
the generating of the second string comprises randomly generating the second string with the length of the first string.

3. The method of claim 1, wherein:
the generating of the document comprises applying a blur effect to the second string.

4. The method of claim 1, further comprising:
receiving a request that comprises an account identifier; and
determining, based on the account identifier, to generate the second string.

5. The method of claim 4, further comprising:
receiving a second request that comprises a second account identifier; and
in response to the second request, generating, based on the document template, a second document comprising the first string.

6. The method of claim 1, further comprising:
based on the identifier of the first data element and the document template, determine a second data value that depends on the first data value;
determining a second length of a third string representation of the second data value; and
based on the determined second length, generating a fourth string;
wherein the generating of the document is further based on the fourth string.

7. The method of claim 1, further comprising:
determining a font size of the first string;
wherein the generating of the second string is further based on the font size.

8. The method of claim 1, further comprising:
determining a color of the first string;
wherein the generating of the second string is further based on the color.

9. The method of claim 1, further comprising:
determining a font of the first string;
wherein the generating of the second string is further based on the font.

10. The method of claim 1, further comprising:
determining that the first string comprises a number of digits;
wherein the generating of the second string is further based on the number of digits.

11. The method of claim 1, further comprising:
determining that the first string comprises a number of letters;
wherein the generating of the second string is further based on the number of letters.

12. A device comprising:
a memory that stores instructions; and
one or more processors configured by the instructions to perform operations comprising:
accessing a document template that references a plurality of data elements;
accessing an identifier of a first data element of the plurality of data elements;
based on the identifier of the first data element, determining a first data value of the first data element;
determining a length of a first string for the first data value;
based on the determined length, generating a second string; and
generating, based on the document template and the second string, a document.

13. The device of claim 12, wherein:
the generating of the second string comprises randomly generating the second string with the length of the first string.

14. The device of claim 12, wherein:
the generating of the document comprises applying a blur effect to the second string.

15. The device of claim 12, wherein the operations further comprise:
receiving a request that comprises an account identifier; and
determining, based on the account identifier, to generate the second string.

16. The device of claim 15, wherein the operations further comprise:
receiving a second request that comprises a second account identifier; and
in response to the second request, generating, based on the document template, a second document comprising the first string.

17. A non-transitory computer-readable medium that stores instructions that, when executed by one or more processors of a device, cause the one or more processors to perform operations comprising:
accessing a document template that references a plurality of data elements;
accessing an identifier of a first data element of the plurality of data elements;
based on the identifier of the first data element, determining a first data value of the first data element;
determining a length of a first string for the first data value;
based on the determined length, generating a second string; and
generating, based on the document template and the second string, a document.

18. The non-transitory computer-readable medium of claim 17, wherein the operations further comprise:
based on the identifier of the first data element and the document template, determine a second data value that depends on the first data element;
determining a second length of a third string representation of the second data value; and
based on the determined second length, generating a fourth string;
wherein the generating of the document is further based on the fourth string.

19. The non-transitory computer-readable medium of claim 17, wherein the operations further comprise:
determining a font size of the first string;
wherein the generating of the second string is further based on the font size.

20. The non-transitory computer-readable medium of claim 17, wherein the operations further comprise:
determining a color of the first string;
wherein the generating of the second string is further based on the color.
